(19) United States
(12) Patent Application Publication
(10) Pub. No.: US 2019/0386278 A1
(43) Pub. Date: Dec. 19, 2019

(54) POROUS LAYER AND NONAQUEOUS ELECTROLYTE SECONDARY BATTERY LAMINATED SEPARATOR

(71) Applicant: Sumitomo Chemical Company, Limited, Tokyo (JP)

(72) Inventor: Toshihiko OGATA, Osaka (JP)

(21) Appl. No.: 16/441,870

(22) Filed: Jun. 14, 2019

(30) Foreign Application Priority Data
Jun. 15, 2018 (JP) 2018-114934

(51) Int. Cl. H01M 2/16; H01M 2/18; H01M 2/14; H01M 10/0525

(52) U.S. Cl. CPC H01M 2/1653; H01M 10/0525; H01M 2/145; H01M 2/18

(57) ABSTRACT

A porous layer and a nonaqueous electrolyte secondary battery laminated separator are provided which are thinner than conventional layers and separators while providing superior heat resistance and battery characteristics. The porous layer contains a heat-resistant resin at a proportion of not less than 40% by weight and not more than 80% by weight and an inorganic material having an average particle diameter of not more than 0.15 μm. The porous layer has a thickness of not less than 0.5 μm and less than 8.0 μm,

This Nonprovisional application claims priority under 35 U.S.C. § 119 on Patent Application No. 2018-114934 filed in Japan on Jun. 15, 2018, the entire contents of which are hereby incorporated by reference.

### TECHNICAL FIELD

The present invention relates to a porous layer and a laminated separator for a nonaqueous electrolyte secondary battery (hereinafter referred to as a “nonaqueous electrolyte secondary battery laminated separator”).

### BACKGROUND ART

Nonaqueous electrolyte secondary batteries, particularly lithium ion secondary batteries, have a high energy density, and are thus in wide use as batteries for personal computers, mobile telephones, portable information terminals, and the like. Such nonaqueous electrolyte secondary batteries have recently been developed as batteries for vehicles.

Patent Literature 1 discloses a nonaqueous electrolyte battery separator containing a heat-resistant nitrogen-containing aromatic polymer and a ceramic powder.

Patent Literature 2 discloses a nonaqueous electrolyte secondary battery separator including (i) a first porous layer (layer A) having a shutdown characteristic so as to become substantially a nonporous layer at a high temperature and (ii) a second porous layer (layer B) containing an aramid resin and an inorganic material, the layer A and the layer B being disposed on one another, a ratio (T_{A}/T_{B}) of a thickness (T_{A}) of the layer A to a thickness (T_{B}) of the layer B being not less than 2.5 and not more than 13.

### CITATION LIST

### Patent Literature

[Patent Literature 1] Japanese Patent Application Publication, Tokukai, No. 2000-030686

[Patent Literature 2] Japanese Patent Application Publication, Tokukai, No. 2007-299612

### SUMMARY OF INVENTION

### Technical Problem

However, in view of a reduction in thickness of a porous layer or a nonaqueous electrolyte secondary battery laminated separator, there is room for further improvement in the foregoing conventional techniques.

An object of an aspect of the present invention is to provide a porous layer or a nonaqueous electrolyte secondary battery laminated separator, each of which is thinner than a conventional one while being equal to or more excellent than the conventional one in heat resistance and battery characteristics.

### Solution to Problem

The present invention encompasses the following features.
<1> A porous layer containing:

a heat-resistant resin; and

an inorganic material,

the porous layer containing the heat-resistant resin at a proportion of not less than 40% by weight and not more than 80% by weight,

the porous layer having a thickness of not less than 0.5 μm and less than 8.0 μm,

the inorganic material having an average particle diameter of not more than 0.15 μm.
<2> The porous layer as defined in <1>, further containing at least one kind of resin selected from the group consisting of polyolefins, (meth)acrylate-based resins, fluorine-containing resins, polyamide-based resins, polyester-based resins, and water-soluble polymers.
<3> The porous layer as defined in <2>, wherein the polyamide-based resins are aramid resins.
<4> A nonaqueous electrolyte secondary battery laminated separator including:

a polyolefin porous film; and

a porous layer as defined in any one of <1> through <3>,

the polyolefin porous film and the porous layer being disposed on one another.
<5> A nonaqueous electrolyte secondary battery laminated separator including:

a polyolefin porous film; and

a porous layer containing a heat-resistant resin and an inorganic material,

the polyolefin porous film and the porous layer being disposed on one another,

the porous layer containing the heat-resistant resin at a proportion of not less than 40% by weight and not more than 80% by weight,

a ratio (TA/TB) of a thickness (TA) of the polyolefin porous film to a thickness (TB) of the porous layer being not less than 3 and not more than 10,

the inorganic material having an average particle diameter of not more than 0.15 μm.
<6> The nonaqueous electrolyte secondary battery laminated separator as defined in <5>, wherein the porous layer contains at least one kind of resin selected from the group consisting of polyolefins, (meth)acrylate-based resins, fluorine-containing resins, polyamide-based resins, polyester-based resins, and water-soluble polymers.
<7> The nonaqueous electrolyte secondary battery laminated separator as defined in <6>, wherein the polyamide-based resins are aramid resins.
<8> The nonaqueous electrolyte secondary battery laminated separator as defined in any one of <4> through <7>, wherein the porous layer has a weight per unit area of not less than 0.5 g/m² and not more than 2.0 g/m².
<9> A nonaqueous electrolyte secondary battery member including:

a positive electrode;

a porous layer as defined in any one of <1> through
<3>or a nonaqueous electrolyte secondary battery laminated separator as defined in any one of <4> through <8>; and

a negative electrode,

the positive electrode, the porous layer or the nonaqueous electrolyte secondary battery laminated separator, and the negative electrode being disposed in this order.
<10> A nonaqueous electrolyte secondary battery including a porous layer as defined in any one of <1> through <3> or a nonaqueous electrolyte secondary battery laminated separator as defined in any one of <4> through <8>.

### Advantageous Effects of Invention

According to an aspect of the present invention, a porous layer or a nonaqueous electrolyte secondary battery laminated separator is provided each of which is thinner than a conventional one while being equal to or more excellent than the conventional one in heat resistance and battery characteristics.

### DESCRIPTION OF EMBODIMENTS

The following description will discuss an embodiment of the present invention. Note, however, that the present invention is not limited to the embodiment. The present invention is not limited to arrangements described below, but may be altered in various ways by a skilled person within the scope of the claims. The present invention also encompasses, in its technical scope, any embodiment derived by combining technical means disclosed in differing embodiments. Note that a numerical expression “A to B” herein means “not less than A and not more than B” unless otherwise stated.

[1. Porous Layer]

As used herein, a porous layer is a layer having therein many pores connected to one another so that a gas or a liquid can pass through the layer from one surface to the other.

A porous layer in accordance with an aspect of the present invention is a porous layer containing: a heat-resistant resin; and an inorganic material, the porous layer containing the heat-resistant resin at a proportion of not less than 40% by weight and not more than 80% by weight, the porous layer having a thickness of not less than 0.5 μm and less than 8.0 μm, the inorganic material having an average particle diameter of not more than 0.15 μm.

The porous layer is arranged such that (i) the porous layer contains the heat-resistant resin at a higher proportion than a conventional one and (ii) the inorganic material has a smaller average particle diameter than a conventional one. By combining such materials, it is possible to prepare a thinner porous layer. Thinning of the porous layer has allowed the porous layer to achieve sufficient battery characteristics.

The porous layer in accordance with an embodiment of the present invention has a thickness of preferably not less than 0.5 μm and less than 8.0 μm, more preferably not less than 1.0 μm and less than 5.0 μm, and still more preferably not less than 1.0 μm and less than 3.0 μm. As used herein, the thickness of the porous layer indicates an average thickness per layer.

By causing the porous layer to have a thickness of not less than 1.0 μm, it is possible to sufficiently prevent an internal short circuit of a battery. Furthermore, it is possible to maintain an amount of an electrolyte retained in the porous layer. By causing the porous layer to have a thickness of less than 8.0 μm, it is possible to cause the porous layer to be thinner than the conventional one, while maintaining heat resistance and battery characteristics at levels equal to or higher than those of heat resistance and battery characteristics of the conventional one. Therefore, it is possible to contribute to a reduction in size of a nonaqueous electrolyte secondary battery laminated separator and also a reduction in size of a nonaqueous electrolyte secondary battery.

The porous layer in accordance with an embodiment of the present invention can be disposed between a polyolefin porous film and at least one of a positive electrode and a negative electrode, as a member constituting the nonaqueous electrolyte secondary battery. The porous layer can be formed on one surface or each of both surfaces of the polyolefin porous film. Alternatively, the porous layer can be formed on at least one of a positive electrode active material layer of the positive electrode and a negative electrode active material layer of the negative electrode. Alternatively, the porous layer can be disposed between the polyolefin porous film and at least one of the positive electrode and the negative electrode so as to be in contact with the polyolefin porous film and the at least one of the positive electrode and the negative electrode. The porous layer can be disposed so as to form one layer or two or more layers between the polyolefin porous film and at least one of the positive electrode and the negative electrode.

The porous layer in accordance with an embodiment of the present invention is preferably disposed between the polyolefin porous film and the positive electrode active material layer of the positive electrode. In the following description of physical properties of the porous layer, the physical properties of the porous layer at least means physical properties of the porous layer which is disposed, in a resultant nonaqueous electrolyte secondary battery, between the polyolefin porous film and the positive electrode active material layer of the positive electrode.

The porous layer has a porosity of preferably 20% by volume to 90% by volume, and more preferably 30% by volume to 80% by volume, in order to achieve sufficient ion permeability. The pores in the porous layer each have a diameter of preferably not more than 1.0 μm, and more preferably not more than 0.5 μm. In a case where the pores each have such a diameter, it is possible for the nonaqueous electrolyte secondary battery to achieve sufficient ion permeability.

[Heat-Resistant Resin]

The porous layer in accordance with an embodiment of the present invention contains a heat-resistant resin at a proportion of 40% by weight to 80% by weight, preferably 45% by weight to 75% by weight, and more preferably 50% by weight to 67% by weight. Note that the proportion of the heat-resistant resin contained in the porous layer is calculated while a total weight of the porous layer is regarded as 100% by weight.

The porous layer in accordance with an embodiment of the present invention contains the heat-resistant resin at a higher proportion than the conventional one. Therefore, even in a case where the porous layer is thinner, it is possible to sufficiently bring about a heat-resistant effect derived from the heat-resistant resin.

Examples of the heat-resistant resin in accordance with an embodiment of present invention include: aromatic polyamides such as wholly aromatic polyamides and semi-aromatic polyamides; aromatic polyimides; aromatic polyamide imides; polybenzimidazoles; polyurethanes; and melamine resins.

In particular, the heat-resistant resin is preferably a wholly aromatic polyamide. Note that, as used herein, a wholly aromatic polyamide is also referred to as an aramid resin. Preferable examples of the wholly aromatic polyamides include para-aramids and meta-aramids, and para-aramids are more preferable.

A method of preparing a para-aramid is not limited in particular. Examples of the method include a method in which a para-directing aromatic diamine and a para-directing aromatic dicarboxylic acid halide are subjected to condensation polymerization. In such a case, the para-aramid to be obtained is substantially made up of repeating units which are bonded to one another via amide bonds present at para positions or positions corresponding to the para positions (for example, coaxially opposite positions or parallelly opposite positions, such as the cases of 4,4′-biphenylene, 1,5-naphthalene, and 2,6-naphthalene) on aromatic rings. Examples of the para-aramids include para-aramids each having a para-directing structure or a structure corresponding to the para-directing structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and a paraphenylene terephthalamide/2,6 -dichloroparaphenylene terephthalamide copolymer.

Specific examples of a method of preparing a solution of poly(paraphenylene terephthalamide) (PPTA) include a method including the following steps (1) through (4).
(1) N-methyl-2-pyrrolidone (NMP) is introduced into a flask which has been dried. Then, calcium chloride (which has been dried at 200° C. for 2 hours) is added to the NMP. After that, a resultant solution is heated to 100° C. so that the calcium chloride is completely dissolved.
(2) A temperature of a solution obtained in the step (1) is returned to a room temperature. Then, paraphenylenediamine (PPD) is added to the solution, and then the PPD is completely dissolved.
(3) While a temperature of a solution obtained in the step (2) is maintained at 20±2° C., terephthalic acid dichloride (TPC) is added, to the solution, in 4 separate portions at approximately 10-minute intervals.
(4) While a temperature of a solution obtained in the step (3) is maintained at 20±2° C., the solution was matured for 1 hour to obtain the solution of the PPTA.

A method of preparing a meta-aramid is not limited in particular. Examples of the method include (1) a method in which a meta-directing aromatic diamine and a meta-directing aromatic dicarboxylic acid halide or a para-directing aromatic dicarboxylic acid halide are subjected to condensation polymerization and (2) a method in which a meta-directing aromatic diamine or a para-directing aromatic diamine and a meta-directing aromatic dicarboxylic acid halide are subjected to condensation polymerization. In such a case, the meta-aramid to be obtained includes repeating units which are bonded to one another via amide bonds present at meta positions or positions corresponding to the meta positions on aromatic rings.

[Inorganic Material]

The porous layer in accordance with an embodiment of the present invention contains an inorganic material.

The inorganic material has an average particle diameter of not more than 0.15 μm, preferably not more than 0.10 μm, and more preferably not more than 0.08 μm. Note that, as used herein, the average particle diameter of the inorganic material indicates a volume-based average particle diameter (D50) of the inorganic material. D50 means a particle diameter at 50% in a volume-based cumulative distribution. D50 can be measured with use of, for example, a laser diffraction particle size analyzer (for example, product name: SALD2200, manufactured by Shimadzu Corporation).

The inorganic material contained in the porous layer in accordance with an embodiment of the present invention has a smaller average particle diameter. A conventional porous layer has needed to have a certain degree of thickness so as to secure sufficient heat resistance. Therefore, it has been typical to cause the conventional porous layer to contain an inorganic material having a larger average particle diameter, in order to increase a thickness of the conventional porous layer. However, since the porous layer in accordance with an embodiment of the present invention has sufficient heat resistance due to an increase in the proportion of the heat-resistant resin, the porous layer in accordance with an embodiment of the present invention does not need to contain an inorganic material having a larger average particle diameter. Consequently, thinning of the porous layer has succeeded.

The inorganic material is made up of particles each having a substantially spherical shape, a plate-like shape, a pillar shape, a needle shape, a whisker-like shape, a fibrous shape, or the like. In view of easy formation of uniform pores, the inorganic material is preferably made up of particles each having a substantially spherical shape.

Examples of the inorganic material include materials each made of an inorganic matter, such as metal oxide, metal nitride, metal carbide, metal hydroxide, carbonate, and sulfate. Specific examples include powders such as alumina, boehmite, silica, titanium dioxide, aluminum hydroxide, and calcium carbonate. The inorganic material can be made of one kind of inorganic matter or can be alternatively made of two or more kinds of inorganic matters in combination. Of those inorganic materials, an alumina powder is preferable in view of chemical stability.

The porous layer in accordance with an embodiment of the present invention contains the inorganic material at a proportion of preferably 1% by weight to 60% by weight, more preferably 10% by weight to 50% by weight, and still more preferably 20% by weight to 50% by weight. Note that the proportion of the inorganic material contained in the porous layer is calculated while the total weight of the porous layer is regarded as 100% by weight.

By causing the proportion of the inorganic material to fall within the above range, it is possible to suppress an increase in a weight of the porous layer, and possible to obtain a separator having good ion permeability.

[Other Components]

The porous layer in accordance with an embodiment of the present invention can contain a component other than the above-described components, provided that the porous layer brings about an effect of the present invention.

For example, the porous layer in accordance with an embodiment of the present invention can contain an organic material. Examples of the organic material include: homopolymers and copolymers each of which homopolymers and copolymers is obtained from styrene, vinyl ketone, acrylonitrile, methyl methacrylate, ethyl methacrylate, glycidyl methacrylate, glycidyl acrylate, methyl acrylate, and/or the like; fluorine-based resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. The porous layer can contain one kind of organic material or can alternatively contain two or more kinds of organic materials in combination. Of those organic materials, a polytetrafluoroethylene powder is preferable in view of chemical stability.

As another example, the porous layer in accordance with an embodiment of the present invention can contain a binder resin. The binder resin causes elements, such as the heat-resistant resin, the inorganic material, an electrode plate, and the polyolefin porous film, to adhere to one another.

The binder resin is preferably insoluble in the electrolyte of the nonaqueous electrolyte secondary battery and is preferably electrochemically stable when the nonaqueous electrolyte secondary battery is in normal use. Examples of the binder resin include: polyolefins such as polyethylene, polypropylene, polybutene, and an ethylene-propylene copolymer; (meth)acrylate-based resins; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; of these fluorine-containing resins, fluorine-containing rubber having a glass transition temperature of not more than 23° C.; polyamide-based resins such as aramid resins (aromatic polyamide, wholly aromatic polyamide, and the like); polyimide-based resins; polyester-based resins such as aromatic polyester (for example, polyarylate) and liquid crystalline polyester; rubber such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins each having a melting point or a glass transition temperature of not lower than 180° C., such as polyphenylene ether, polysulfone, polyether sulfone, polyphenylene sulfide, polyether imide, polyamide imide, polyether amide, and polyester; water-soluble polymers such as polyvinyl alcohol, polyethylene glycol, cellulose ether, sodium alginate, polyacrylic acid, polyacrylamide, and polymethacrylic acid; polycarbonates; polyacetals; and polyether ether ketones.

Of those binder resins, polyolefins, (meth)acrylate-based resins, fluorine-containing resins, polyamide-based resins, polyester-based resins, and water-soluble polymers are preferable.

Specific examples of the aramid resins include poly(paraphenylene terephthalamide), poly(metaphenylene isophthalamide), poly(parabenzamide), poly(metabenzamide), poly(4,4′-benzanilide terephthalamide), poly(paraphenylene-4,4′-biphenylene dicarboxylic acid amide), poly(metaphenylene-4,4′-biphenylene dicarboxylic acid amide), poly(paraphenylene-2,6-naphthalene dicarboxylic acid amide), poly(metaphenylene-2 ,6-naphthalene dicarboxylic acid amide), poly(2-chloroparaphenylene terephthalamide), a paraphenylene terephthalamide/2,6-dichloroparaphenylene terephthalamide copolymer, and a metaphenylene terephthalamide/2,6-dichloroparaphenylene terephthalamide copolymer. Of those aramid resins, poly(paraphenylene terephthalamide) is more preferable.

Note that the porous layer can contain one kind of binder resin or can alternatively contain two or more kinds of binder resins in combination.

[Method of Producing Porous Layer]

The porous layer can be formed with use of a coating solution obtained by dissolving or dispersing the heat-resistant resin and the inorganic material in a medium. Examples of a method of forming the coating solution include a mechanical stirring method, an ultrasonic dispersion method, a high-pressure dispersion method, and a media dispersion method. Examples of the medium include N-methylpyrrolidone, N,N-dimethylacetamide, and N,N-dimethylformamide.

Examples of a method of producing the porous layer include a method in which the above-described coating solution is (i) prepared, (ii) applied to a base material, and then (iii) dried so that the porous layer is deposited. As the base material, a porous base material (for example, the polyolefin porous film (later described)), the electrode plate, or the like can be used.

As a method of coating the base material with the coating solution, a publicly known coating method, such as a knife coater method, a blade coater method, a bar coater method, a gravure coater method, or a die coater method, can be employed.

A solvent (dispersion medium) is generally removed by drying the coating solution. Examples of a method of drying the coating solution include natural drying, air-blowing drying, heat drying, and drying under reduced pressure. Note, however, that any method can be employed, provided that the solvent (dispersion medium) can be sufficiently removed. Note that the coating solution can be dried after the solvent (dispersion medium) contained in the coating solution is replaced with another solvent. Specific examples of a method of replacing the solvent (dispersion medium) with another solvent and then removing the another solvent include a method in which (i) the solvent (dispersion medium) is replaced with a poor solvent having a low boiling point, such as water, alcohol, or acetone, (ii) the porous layer is deposited, and then (iii) the porous layer is dried.

[2 Nonaqueous Electrolyte Secondary Battery Laminated Separator]

A nonaqueous electrolyte secondary battery laminated separator in accordance with an aspect of the present invention is a nonaqueous electrolyte secondary battery laminated separator including: a polyolefin porous film; and a porous layer as described in [1], the polyolefin porous film and the porous layer being disposed on one another.

A nonaqueous electrolyte secondary battery laminated separator in accordance with another aspect of the present invention is a nonaqueous electrolyte secondary battery laminated separator including: a polyolefin porous film; and a porous layer containing a heat-resistant resin and an inorganic material, the polyolefin porous film and the porous layer being disposed on one another, the porous layer containing the heat-resistant resin at a proportion of not less than 40% by weight and not more than 80% by weight, a ratio (TA/TB) of a thickness (TA) of the polyolefin porous film to a thickness (TB) of the porous layer being not less than 3 and not more than 10, the inorganic material having an average particle diameter of not more than 0.15 μm.

The ratio (TA/TB) of the thickness (TA) of the polyolefin porous film to the thickness (TB) of the porous layer is 3 to 10, preferably 3 to 8, and more preferably 3 to 7.

In a case where a value of TA/TB falls within the above range, it is possible to cause the porous layer to be sufficiently thinner than a conventional one while maintaining heat resistance and battery characteristics at levels equal to or higher than those of heat resistance and battery characteristics of the conventional one. Therefore, it is possible to cause the nonaqueous electrolyte secondary battery laminated separator to be thinner in whole, and possible to contribute to a reduction in size of a nonaqueous electrolyte secondary battery.

A proportion of the heat-resistant resin and an average particle diameter of the inorganic material are as described in [1], and therefore will not be described again.

The nonaqueous electrolyte secondary battery laminated separator in accordance with an embodiment of the present invention is a laminated separator in which the porous layer is disposed on the polyolefin porous film. The porous layer can be disposed on one surface or each of both surfaces of the polyolefin porous film.

The nonaqueous electrolyte secondary battery laminated separator in accordance with an embodiment of the present invention can include, in addition to the polyolefin porous film and the porous layer, a publicly known porous film such as an adhesive layer and a protective layer as necessary, provided that the publicly known porous film does not prevent the object of the present invention from being attained.

The porous layer included in the nonaqueous electrolyte secondary battery laminated separator in accordance with an embodiment of the present invention has a weight per unit area of preferably 0.5 g/m² to 2.0 g/m², more preferably 1.0 g/m² to 2.0 g/m², and still more preferably 1.0 g/m² to 1.8 g/m², in terms of solid content. It is preferable to cause the weight per unit area to fall within the above range, in order to achieve the above-described preferable range of the value of TA/TB or to achieve a preferable thickness, described in [1], of the porous layer.

The nonaqueous electrolyte secondary battery laminated separator in accordance with an embodiment of the present invention has a thickness of preferably 4 μm to 20 μm, and more preferably 6 μm to 16 μm. By causing the nonaqueous electrolyte secondary battery laminated separator to have a thickness falling within the above range, it is possible to achieve thinning of the nonaqueous electrolyte secondary battery laminated separator, which is an object of the present invention.

The nonaqueous electrolyte secondary battery laminated separator in accordance with an embodiment of the present invention has an air permeability of preferably 30 sec/100 mL to 1000 sec/100 mL, and more preferably 50 sec/100 mL to 800 sec/100 mL, in terms of Gurley values. In a case where the nonaqueous electrolyte secondary battery laminated separator has such an air permeability, it is possible for the nonaqueous electrolyte secondary battery laminated separator to achieve sufficient ion permeability in the nonaqueous electrolyte secondary battery.

[Polyolefin Porous Film]

The nonaqueous electrolyte secondary battery laminated separator in accordance with an embodiment of the present invention includes the polyolefin porous film. The polyolefin porous film has therein many pores connected to one another so that a gas and/or a liquid can pass through the polyolefin porous film from one surface to the other. The polyolefin porous film can be a base material of the nonaqueous electrolyte secondary battery laminated separator. The polyolefin porous film can impart a shutdown function to the nonaqueous electrolyte secondary battery laminated separator by melting and thereby making the nonaqueous electrolyte secondary battery laminated separator non-porous, in a case where the battery generates heat.

Note, here, that the “polyolefin porous film” indicates a porous film which contains a polyolefin-based resin as a main component. Note that the phrase “contains a polyolefin-based resin as a main component” means that the porous film contains the polyolefin-based resin at a proportion of not less than 50% by volume, preferably not less than 90% by volume, and more preferably not less than 95% by volume, with respect to the whole of materials of which the porous film is made.

The polyolefin-based resin which the polyolefin porous film contains as a main component is not limited in particular. Examples of the polyolefin-based resin include homopolymers and copolymers each of which homopolymers and copolymers is a thermoplastic resin and is produced through polymerization of a monomer(s) such as ethylene, propylene, 1-butene, 4-methyl-1-pentene, and/or 1-hexene. Specifically, examples of such homopolymers include polyethylene, polypropylene, and polybutene, and examples of such copolymers include an ethylene-propylene copolymer. The polyolefin porous film can be a layer containing one kind of polyolefin-based resin or can be alternatively a layer containing two or more kinds of polyolefin-based resins. Of those polyolefin-based resins, polyethylene is preferable because it is possible to prevent (shut down), at a lower temperature, a flow of an excessively large electric current. In particular, high molecular weight polyethylene which contains ethylene as a main component is preferable. Note that the polyolefin porous film can contain a component other than polyolefin, provided that the component does not impair a function of the polyolefin porous film.

Examples of the polyethylene include low-density polyethylene, high-density polyethylene, linear polyethylene (ethylene-a-olefin copolymer), and ultra-high molecular weight polyethylene. Out of those polyethylenes, ultra-high molecular weight polyethylene is more preferable, and ultra-high molecular weight polyethylene which contains a high molecular weight component having a weight-average molecular weight of 5×10⁵ to 15×10⁶ is still more preferable. In particular, the polyolefin-based resin which contains a high molecular weight component having a weight-average molecular weight of not less than 1,000,000 is more preferable, because such a polyolefin-based resin allows the polyolefin porous film and the nonaqueous electrolyte secondary battery laminated separator to each have increased strength.

The pores in the polyolefin porous film each have a diameter of preferably not more than 0.1 μm, and more preferably not more than not more than 0.06 μm. This makes it possible for the polyolefin porous film to achieve sufficient ion permeability. Furthermore, this makes it possible to prevent particles, constituting an electrode, from entering the polyolefin porous film.

The polyolefin porous film typically has a weight per unit area of preferably 4 g/m² to 20 g/m², and more preferably 5 g/m² to 12 g/m², so as to allow the nonaqueous electrolyte secondary battery to have a higher weight energy density and a higher volume energy density.

The polyolefin porous film has an air permeability of preferably 30 sec/100 mL to 500 sec/100 mL, and more preferably 50 sec/100 mL to 300 sec/100 mL, in terms of Gurley values. This allows the nonaqueous electrolyte secondary battery laminated separator to achieve sufficient ion permeability.

The polyolefin porous film has a porosity of preferably 20% by volume to 80% by volume, and more preferably 30% by volume to 75% by volume. This makes it possible to (i) increase an amount of an electrolyte retained in the polyolefin porous film and (ii) absolutely prevent (shut down), at a lower temperature, a flow of an excessively large electric current.

A method of producing the polyolefin porous film is not limited in particular, and any publicly known method can be employed. For example, as disclosed in Japanese Patent No. 5476844, a method can be employed in which (i) a filler is added to a thermoplastic resin, (ii) the thermoplastic resin to which the filler is added is formed into a film, and then (iii) the filler is removed.

Specifically, in a case where, for example, the polyolefin porous film is made of a polyolefin-based resin containing ultra-high molecular weight polyethylene and low molecular weight polyolefin which has a weight-average molecular weight of not more than 10,000, the polyolefin porous film is preferably produced by, in view of production costs, a method including the following steps (1) through (4):
(1) kneading (i) 100 parts by weight of ultra-high molecular weight polyethylene, (ii) 5 parts by weight to 200 parts by weight of low molecular weight polyolefin having a weight-average molecular weight of not more than 10,000, and (iii) 100 parts by weight to 400 parts by weight of an inorganic filler such as calcium carbonate to obtain a polyolefin-based resin composition;
(2) forming the polyolefin-based resin composition into a sheet;
(3) removing the inorganic filler from the sheet obtained in the step (2); and
(4) stretching the sheet obtained in the step (3).
   Alternatively, the polyolefin porous film can be produced by a method disclosed in any of the foregoing Patent Literatures.

Alternatively, the polyolefin porous film can be a commercially available product having the above-described characteristics.

[Method of Producing Nonaqueous Electrolyte Secondary Battery Laminated Separator]

Examples of a method of producing the nonaqueous electrolyte secondary battery laminated separator in accordance with an embodiment of the present invention include a method in which, in the above-described “Method of producing porous layer”, the polyolefin porous film is used as the base material to which the coating solution is applied.

[3. Nonaqueous Electrolyte Secondary Battery Member and Nonaqueous Electrolyte Secondary Battery]

A member for a nonaqueous electrolyte secondary battery (hereinafter referred to as a “nonaqueous electrolyte secondary battery member”) in accordance with an embodiment of the present invention includes a positive electrode, a porous layer as described above or a nonaqueous electrolyte secondary battery laminated separator as described above, and a negative electrode, the positive electrode, the porous layer or the nonaqueous electrolyte secondary battery laminated separator, and the negative electrode being disposed in this order. A nonaqueous electrolyte secondary battery in accordance with an embodiment of the present invention includes a porous layer as described above or a nonaqueous electrolyte secondary battery laminated separator as described above. The nonaqueous electrolyte secondary battery has a structure in which, typically, a negative electrode and a positive electrode face each other via the porous layer as described above or the nonaqueous electrolyte secondary battery laminated separator as described above. The nonaqueous electrolyte secondary battery is arranged such that a battery element is enclosed in an exterior member, the battery element including the structure and an electrolyte with which the structure is impregnated. For example, the nonaqueous electrolyte secondary battery is a lithium ion secondary battery which achieves an electromotive force through doping with and dedoping of lithium ions.

[Positive Electrode]

The positive electrode can be, for example, a positive electrode sheet having a structure in which a positive electrode active material layer, containing a positive electrode active material and a binding agent, is formed on a positive electrode current collector. The positive electrode active material layer can further contain an electrically conductive agent.

Examples of the positive electrode active material include materials each capable of being doped with and dedoped of lithium ions. Examples of the material include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and a fired product of an organic polymer compound.

Examples of the binding agent include: thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, thermoplastic polyimide, polyethylene, and polypropylene; acrylic resins; and styrene-butadiene rubber. Note that the binding agent serves also as a thickener.

Examples of the positive electrode current collector include electric conductors such as Al, Ni, and stainless steel. Of those electric conductors, Al is more preferable because Al is easily processed into a thin film and is inexpensive.

Examples of a method of producing the positive electrode sheet include: a method in which the positive electrode active material, the electrically conductive agent, and the binding agent which constitute a positive electrode mix are pressure-molded on the positive electrode current collector; and a method in which (i) the positive electrode active material, the electrically conductive agent, and the binding agent are formed into a paste with use of an appropriate organic solvent to obtain the positive electrode mix, (ii) the positive electrode current collector is coated with the positive electrode mix, and then (iii) a sheet-shaped positive electrode mix obtained by drying the positive electrode mix is pressured on the positive electrode current collector so that the sheet-shaped positive electrode mix is firmly fixed to the positive electrode current collector.

[Negative Electrode]

The negative electrode can be, for example, a negative electrode sheet having a structure in which a negative electrode active material layer, containing a negative electrode active material and a binding agent, is formed on a negative electrode current collector. The negative electrode active material layer can further contain an electrically conductive agent.

Examples of the negative electrode active material include: materials each capable of being doped with and dedoped of lithium ions; lithium metal; and lithium alloy. Examples of the materials include: carbonaceous materials such as natural graphite, artificial graphite, cokes, carbon black, pyrolytic carbons, carbon fiber, and a fired product of an organic polymer compound; chalcogen compounds, such as oxides and sulfides, each of which is doped with and dedoped of lithium ions at an electric potential lower than that for the positive electrode; metal, such as aluminum (Al), lead (Pb), tin (Sn), bismuth (Bi), and silicon (Si), which is alloyed with alkali metal; cubic intermetallic compounds (AlSb, Mg₂Si, NiSi₂) in each of which alkali metal can be inserted in a space in a lattice; and lithium nitrogen compounds (Li₃₋ₓMₓN (M: transition metal)).

Examples of the negative electrode current collector include Cu, Ni, and stainless steel. In particular, Cu is more preferable because Cu is not easily alloyed with lithium in a lithium ion secondary battery and is easily processed into a thin film.

Examples of a method of producing the negative electrode sheet include: a method in which the negative electrode active material which constitutes a negative electrode mix is pressure-molded on the negative electrode current collector; and a method in which (i) the negative electrode active material is formed into a paste with use of an appropriate organic solvent to obtain the negative electrode mix, (ii) the negative electrode current collector is coated with the negative electrode mix, and then (iii) a sheet-shaped negative electrode mix obtained by drying the negative electrode mix is pressed on the negative electrode current collector so that the sheet-shaped negative electrode mix is firmly fixed to the negative electrode current collector. The paste preferably contains the electrically conductive agent and a binding agent as described above.

[Nonaqueous Electrolyte]

A nonaqueous electrolyte can be, for example, a nonaqueous electrolyte obtained by dissolving a lithium salt in an organic solvent. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. Of those lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Examples of the organic solvent include: carbonates such as ethylene carbonate, propylene carbonate, dimethyl carbonate, diethyl carbonate, ethyl methyl carbonate, 4-trifluoromethyl-1,3-dioxolane-2-one, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into an organic solvent as described above. Of those organic solvents, carbonates are more preferable, and a mixed solvent of a cyclic carbonate and an acyclic carbonate or a mixed solvent of a cyclic carbonate and an ether is still more preferable. As the mixed solvent of a cyclic carbonate and an acyclic carbonate, a mixed solvent of ethylene carbonate, dimethyl carbonate, and ethyl methyl carbonate is still more preferable. Such a mixed solvent allows a wider operating temperature range, and is not easily decomposed even in a case where a graphite material such as natural graphite or artificial graphite is used as the negative electrode active material.

[Method of Producing Nonaqueous Electrolyte Secondary Battery Member and Method of Producing Nonaqueous Electrolyte Secondary Battery]

Examples of a method of producing the nonaqueous electrolyte secondary battery member include a method in which the positive electrode, the porous layer as described above or the nonaqueous electrolyte secondary battery laminated separator as described above, and the negative electrode are disposed in this order.

Examples of a method of producing the nonaqueous electrolyte secondary battery include the following method. First, the nonaqueous electrolyte secondary battery member is placed in a container which is to serve as a housing of the nonaqueous electrolyte secondary battery. Next, the container is filled with the nonaqueous electrolyte, and then the container is hermetically sealed while a pressure inside the container is reduced. As a result, it is possible to produce the nonaqueous electrolyte secondary battery.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss an embodiment of the present invention in more detail with reference to Examples and Comparative Examples below. Note, however, that the present invention is not limited to such Examples and Comparative Examples.

[Methods of Measuring Various Physical Properties]

Physical properties of a nonaqueous electrolyte secondary battery laminated separator prepared in each of Examples and Comparative Examples below were measured by methods below.

(1) Dimension Retaining Rate

A 5 cm×5 cm square piece was cut out of a nonaqueous electrolyte secondary battery laminated separator prepared in each of Examples and Comparative Examples, and was marked with a 4 cm×4 cm square at its center. Next, the square piece thus cut out of the nonaqueous electrolyte secondary battery laminated separator was sandwiched between two sheets of paper, and was heated in an oven at 150° C. for 1 hour. The square piece thus heated was taken out, and a size of the square with which the square piece was marked was measured to calculate a dimension retaining rate. The dimension retaining rate was calculated as follows:

Dimension retaining rate (%) in machine direction(MD)=(W2/W1)×100

where: W1 represents a length of the square in the machine direction (MD) before heating; and
W2 represents the length of the square in the machine direction (MD) after the heating.

(2) Initial Battery Characteristic Maintaining Rate

As described below, a nonaqueous electrolyte secondary battery was assembled with use of the nonaqueous electrolyte secondary battery laminated separator prepared in each of Examples and Comparative Examples, and an initial battery characteristic maintaining rate was measured.

(Positive Electrode)

A commercially available positive electrode was prepared which had been produced by applying LiNi_{0.5}Mn_{0.3}Co_{0.2}O₂, an electrically conductive agent, and PVDF (at a weight ratio of 92:5:3) to aluminum foil. The aluminum foil of the commercially available positive electrode was cut so that (i) a first portion of the aluminum foil, on which first portion a positive electrode active material layer was formed, had a size of 40 mm×35 mm and (ii) a second portion of the aluminum foil, on which second portion no positive electrode active material layer was formed and which second portion had a width of 13 mm, remained on an outer periphery of the first portion. A positive electrode thus obtained was used. The positive electrode active material layer had a thickness of 58 μm and a density of 2.50 g/cm³.

(Negative Electrode)

A commercially available negative electrode was prepared which had been produced by applying graphite, a styrene-1,3-butadiene copolymer, and sodium carboxymethylcellulose (at a weight ratio of 98:1:1) to copper foil. The copper foil of the commercially available negative electrode was cut so that (i) a first portion of the copper foil, on which first portion a negative electrode active material layer was formed, had a size of 50 mm×40 mm and (ii) a second portion of the copper foil, on which second portion no negative electrode active material layer was formed and which second portion had a width of 13 mm, remained on an outer periphery of the first portion. A negative electrode thus obtained was used. The negative electrode active material layer had a thickness of 49 μm and a density of 1.40 g/cm³.

(Assembly of Nonaqueous Electrolyte Secondary Battery)

The positive electrode, the nonaqueous electrolyte secondary battery laminated separator, and the negative electrode were disposed in this order in a laminate pouch to obtain a nonaqueous electrolyte secondary battery member. In so doing, the positive electrode and the negative electrode were arranged so that a main surface of the positive electrode active material layer of the positive electrode was entirely included in a range of a main surface of the negative electrode active material layer of the negative electrode (i.e., entirely covered by the main surface of the negative electrode active material layer of the negative electrode).

Subsequently, the nonaqueous electrolyte secondary battery member was put into a bag which had been formed by disposing an aluminum layer on a heat seal layer. Into the bag, 0.25 mL of a nonaqueous electrolyte was further put. The nonaqueous electrolyte was prepared by dissolving LiPF₆ at a concentration of 1.0 mol/L in a mixed solvent obtained by mixing up ethyl methyl carbonate, diethyl carbonate, and ethylene carbonate at a volume ratio of 50:20:30. A temperature of the nonaqueous electrolyte was set to 25° C. The bag was then heat-sealed while pressure inside the bag was reduced. As a result, a nonaqueous electrolyte secondary battery was prepared.

(Measurement of Initial Battery Characteristic Maintaining Rate)

A new nonaqueous electrolyte secondary battery, which had not been subjected to a charge-discharge cycle, was subjected to 4 initial charge-discharge cycles. Each of the 4 initial charge-discharge cycles was carried out under the following conditions: (i) a voltage was set to a range of 2.7 V to 4.1 V; (ii) CC-CV charge was carried out at a charge rate of 0.2 C (final charge rate: 0.02 C); and (iii) CC discharge was carried out at a discharge rate of 0.2 C. The 4 initial charge-discharge cycle were carried out at 25° C.

Note that, in the above description, 1 C indicates a rate at which a rated capacity derived from a 1-hour rate discharge capacity is discharged in 1 hour. Note also that the “CC-CV charge” indicates a charging method in which (i) a battery is charged with a constant electric current until a given voltage is reached and then (ii) the battery is charged while the electric current is reduced so that the given voltage is maintained. Note also that the “CC discharge” indicates a discharging method in which, while a constant electric current is maintained, a battery is discharged until a given voltage is reached.

Then, the initial battery characteristic maintaining rate was calculated in accordance with the following expression. Measurement was carried out at 55° C. Initial battery characteristic maintaining rate (%)=(20 C discharge capacity/0.2 C discharge capacity)×100

[Example Production of Aramid Polymerization Solution]

Aramid fine particles used in each of Examples and Comparative Examples were prepared as follows.

Poly(paraphenylene terephthalamide) was prepared as aramid. As a vessel for preparation, a separable flask was used which had a capacity of 500 mL and which had a stirring blade, a thermometer, a nitrogen incurrent canal, and a powder addition port. Into the flask which had been sufficiently dried, 440 g of N-methyl-2-pyrrolidone (NMP) was introduced. Then, 30.2 g of a calcium chloride powder (which had been dried in a vacuum at 200° C. for 2 hours) was added to the NMP. After that, a resultant solution was heated to 100° C. so that the calcium chloride powder was completely dissolved. Subsequently, a temperature of the solution was returned to a room temperature. Then, 13.2 g of paraphenylenediamine was added to the solution, and the paraphenylenediamine was completely dissolved. While the temperature of the solution was maintained at 20° C.±2° C., 24.2 g of terephthalic acid dichloride was added, to the solution, in 4 separate portions at approximately 10-minute intervals. Thereafter, while the solution was stirred at 150 rpm, the solution was matured for 1 hour in a state where the temperature of the solution was maintained at 20° C.±2° C. This produced an aramid polymerization solution containing 6% by weight of poly(paraphenylene terephthalamide).

### Example 1

Into a flask, 100 g of the aramid polymerization solution prepared in the foregoing production example was introduced. Then, 6 g of Alumina C (available from Nippon Aerosil Co., Ltd., having an average particle diameter of 0.013 μm) was mixed into the aramid polymerization solution. After that, NMP was further added to a resultant solution so that the solution contained 4% by weight of a solid content. The solution was then stirred for 240 minutes. Note that the “solid content” here indicates a total weight of the poly(paraphenylene terephthalamide) and the Alumina C. Thereafter, 2.36 g of calcium carbonate was added to the solution. The solution thus obtained was stirred for 240 minutes so that the solution was neutralized. The solution was then defoamed under a reduced pressure. This produced a coating solution (1) in the form of slurry.

The coating solution (1) was applied, by a doctor blade method, to a porous film (having a thickness of 10 pm and a porosity of 42%) made of polyethylene. A resultant coated porous film (1) was left to stand still in the air at 50° C. and a relative humidity of 70% for 1 minute so that a layer containing particles of poly(paraphenylene terephthalamide) was deposited. Next, the coated porous film (1) was immersed in ion-exchange water so that calcium chloride and a solvent were removed. Thereafter, the coated porous film (1) was dried in an oven at 70° C. to obtain a nonaqueous electrolyte secondary battery laminated separator (1). Table 1 shows physical properties of the nonaqueous electrolyte secondary battery laminated separator (1).

### Example 2

A coating solution (2) was prepared by (i) mixing 3 g of Alumina C (available from Nippon Aerosil Co., Ltd.) into the aramid polymerization solution and (ii) adding NMP to a resultant solution so that the solution contained 3% by weight of a solid content. With use of the coating solution (2), a nonaqueous electrolyte secondary battery laminated separator (2) was obtained by a procedure similar to that in Example 1. Table 1 shows physical properties of the nonaqueous electrolyte secondary battery laminated separator (2).

### Example 3

A coating solution (3) was prepared by (i) mixing 2 g of Alumina C (available from Nippon Aerosil Co., Ltd.) into the aramid polymerization solution and (ii) adding NMP to a resultant solution so that the solution contained 2.67% by weight of a solid content. With use of the coating solution (3), a nonaqueous electrolyte secondary battery laminated separator (3) was obtained by a procedure similar to that in Example 1. Table 1 shows physical properties of the nonaqueous electrolyte secondary battery laminated separator (3).

### Comparative Example 1

Into a flask, 100 g of the aramid polymerization solution prepared in the foregoing production example was introduced. Then, 6 g of Alumina C (available from Nippon Aerosil Co., Ltd., having an average particle diameter of 0.013 μm) and 6 g of AKP-3000 (available from Sumitomo Chemical Co., Ltd., having an average particle diameter of 0.7 μm) were mixed into the aramid polymerization solution. After that, NMP was further added to a resultant solution so that the solution contained 6% by weight of a solid content. The solution was then stirred for 240 minutes. Note that the “solid content” here indicates a total weight of the poly(paraphenylene terephthalamide), the Alumina C, and the AKP-3000. Note also that an average particle diameter of an inorganic material (Alumina C and AKP-3000) used in Comparative Example 1 was 0.35 pm as a whole. Thereafter, by a procedure similar to that in Example 1, a comparative coating solution (1) was prepared, and then a comparative nonaqueous electrolyte secondary battery laminated separator (1) was obtained. Table 1 shows physical properties of the comparative nonaqueous electrolyte secondary battery laminated separator (1).

TABLE 1

| | Pro- | Thickness | Thick- | Weight | | |
|---|---|---|---|---|---|---|
| | portion | (TA) of | ness | per unit | | Di- |
| | of heat- | polyolefin | (TB) of | area of | | mension |
| | resistant | porous | porous | porous | | retaining |
| | resin | film | layer | layer | | rate |
| | (%) | (μm) | (μm) | (g/m²) | TA/TB | (%) |
| Example 1 | 50 | 10 | 2.5 | 1.6 | 4.0 | 87.5 |
| Example 2 | 67 | 10 | 1.8 | 1.2 | 5.6 | 92.5 |
| Example 3 | 75 | 10 | 1.6 | 1.2 | 6.3 | 90.0 |
| Comparative | 33 | 10 | 4.0 | 2.5 | 2.5 | 87.5 |
| Example 1 | | | | | | |

### Example 4

By a procedure similar to that in Example 1, a nonaqueous electrolyte secondary battery laminated separator (4) was obtained with use of the coating solution (2) obtained in Example 2 and a porous film (having a thickness of 12 μm and a porosity of 41%) made of polyethylene. Table 2 shows physical properties of the nonaqueous electrolyte secondary battery laminated separator (4).

### Comparative Example 2

By a procedure similar to that in Example 1, a comparative nonaqueous electrolyte secondary battery laminated separator (2) was obtained with use of the comparative coating solution (1) obtained in Comparative Example 1 and a porous film (having a thickness of 12 μm and a porosity of 41%) made of polyethylene. Table 2 shows physical properties of the comparative nonaqueous electrolyte secondary battery laminated separator (2).

TABLE 2

| | | Thickness | | Weight | | |
|---|---|---|---|---|---|---|
| | Proportion | (TA) of | Thickness | per unit | | Initial battery |
| | of heat- | polyolefin | (TB) of | area of | Dimension | characteristic |
| | resistant | porous | porous | porous | retaining | maintaining |
| | resin | film | layer | layer | rate | rate |
| | (%) | (μm) | (μm) | (g/m²) | (%) | (%) |
| Example 4 | 67 | 12 | 2.2 | 1.2 | 70.0 | 76.0 |
| Comparative | 33 | 12 | 4.0 | 2.6 | 70.0 | 70.0 |
| Example 2 | | | | | | |

(Results)

The porous layers in Examples are different, in composition, from those in Comparative Examples. Specifically, the porous layers prepared in Examples 1 through 4 each (i) contained the heat-resistant resin at a proportion falling within a range of not less than 40% by weight and not more than 80% by weight and (ii) contained the inorganic material having an average particle diameter of not more than 0.15 μm, while the porous layers prepared in Comparative Examples 1 and 2 each (i) contained the heat-resistant resin at a proportion of less than 40% by weight and (ii) contained the inorganic material having an average particle diameter of more than 0.15 μm.

As a result, although the nonaqueous electrolyte secondary battery laminated separators (1) through (3) included the respective porous layers each of which was thinner in thickness (TB) and lower in weight per unit area, the nonaqueous electrolyte secondary battery laminated separators (1) through (3) each exhibited a dimension retaining rate equal to or higher than that of the comparative nonaqueous electrolyte secondary battery laminated separator (1) (Table 1). A similar relationship was also established between the nonaqueous electrolyte secondary battery laminated separator (4) and the comparative nonaqueous electrolyte secondary battery laminated separator (2) (Table 2).

According to comparison between the nonaqueous electrolyte secondary battery laminated separator (4) and the comparative nonaqueous electrolyte secondary battery laminated separator (2), the nonaqueous electrolyte secondary battery laminated separator (4) had a more excellent initial battery characteristic maintaining rate (Table 2).

The above results suggested that, according to the features of the present invention, even in a case where a porous layer disposed is thinner, it is possible to obtain a nonaqueous electrolyte secondary battery laminated separator which is equal to or more excellent than a conventional one in heat resistance and battery characteristics. In other words, the present invention can contribute to thinning of a porous layer, and also can contribute to thinning of a nonaqueous electrolyte secondary battery laminated separator.

### INDUSTRIAL APPLICABILITY

The present invention is applicable to, for example, a nonaqueous electrolyte secondary battery.

1. A porous layer comprising:
a heat-resistant resin; and
an inorganic material,
the porous layer containing the heat-resistant resin at a proportion of not less than 40% by weight and not more than 80% by weight,
the porous layer having a thickness of not less than 0.5 μm and less than 8.0 μm,
the inorganic material having an average particle diameter of not more than 0.15 μm.

2. The porous layer as set forth in claim 1, further comprising at least one kind of resin selected from the group consisting of polyolefins, (meth)acrylate-based resins, fluorine-containing resins, polyamide-based resins, polyester-based resins, and water-soluble polymers.

3. The porous layer as set forth in claim 2, wherein the polyamide-based resins are aramid resins.

4. A nonaqueous electrolyte secondary battery laminated separator comprising:
a polyolefin porous film; and
a porous layer recited in claim 1,
the polyolefin porous film and the porous layer being disposed on one another.

5. A nonaqueous electrolyte secondary battery laminated separator comprising:
a polyolefin porous film; and
a porous layer containing a heat-resistant resin and an inorganic material,
the polyolefin porous film and the porous layer being disposed on one another,
the porous layer containing the heat-resistant resin at a proportion of not less than 40% by weight and not more than 80% by weight,
a ratio (TA/TB) of a thickness (TA) of the polyolefin porous film to a thickness (TB) of the porous layer being not less than 3 and not more than 10,
the inorganic material having an average particle diameter of not more than 0.15 μm.

6. The nonaqueous electrolyte secondary battery laminated separator as set forth in claim 5, wherein the porous layer contains at least one kind of resin selected from the group consisting of polyolefins, (meth)acrylate-based resins, fluorine-containing resins, polyamide-based resins, polyester-based resins, and water-soluble polymers.

7. The nonaqueous electrolyte secondary battery laminated separator as set forth in claim 6, wherein the polyamide-based resins are aramid resins.

8. The nonaqueous electrolyte secondary battery laminated separator as set forth in claim 4, wherein the porous layer has a weight per unit area of not less than 0.5 g/m² and not more than 2.0 g/m².

9. The nonaqueous electrolyte secondary battery laminated separator as set forth in claim 5, wherein the porous layer has a weight per unit area of not less than 0.5 g/m² and not more than 2.0 g/m².

10. A nonaqueous electrolyte secondary battery member comprising:
a positive electrode;
a porous layer recited in claim 1; and
a negative electrode,
the positive electrode, the porous layer, and the negative electrode being disposed in this order.

11. A nonaqueous electrolyte secondary battery comprising a porous layer recited in claim 1.

12. A nonaqueous electrolyte secondary battery member comprising:
a positive electrode;
a nonaqueous electrolyte secondary battery laminated separator recited in claim 4; and
a negative electrode,
the positive electrode, the nonaqueous electrolyte secondary battery laminated separator, and the negative electrode being disposed in this order.

13. A nonaqueous electrolyte secondary battery comprising a nonaqueous electrolyte secondary battery laminated separator recited in claim 4.

14. A nonaqueous electrolyte secondary battery member comprising:
a positive electrode;
a nonaqueous electrolyte secondary battery laminated separator recited in claim 5; and
a negative electrode,
the positive electrode, the nonaqueous electrolyte secondary battery laminated separator, and the negative electrode being disposed in this order.

15. A nonaqueous electrolyte secondary battery comprising a nonaqueous electrolyte secondary battery laminated separator recited in claim 5.
